(19) United States
(12) Patent Application Publication
(10) Pub. No.: US 2010/0123596 A1
(43) Pub. Date: May 20, 2010

(54) Mather Line Monitor

(76) Inventor: David K. Mather, Troy, MI (US)

Correspondence Address: David K. Mather, 2908 Briarwood Court, Troy, MI, 48085, US

(21) Appl. No.: 12/313,285

(22) Filed: Nov. 19, 2008

(51) Int. Cl. G08B 5/00

(52) U.S. Cl. 340/815.4

(57) ABSTRACT

The invention of the line monitor system is illustrated in the drawings labeled FIG. 1 and FIG. 2. The primary purpose is to show where lines are formed and how long the wait is in the lines to the nearest 15 minute time interval. The times are to be updated by people monitoring the lines. Each line is to be updated every 15 minutes by the person monitoring the line. Once updated, the length of the line would be available for all to see from various places within the site as shown on the sign which is FIG. 1 of the drawings.

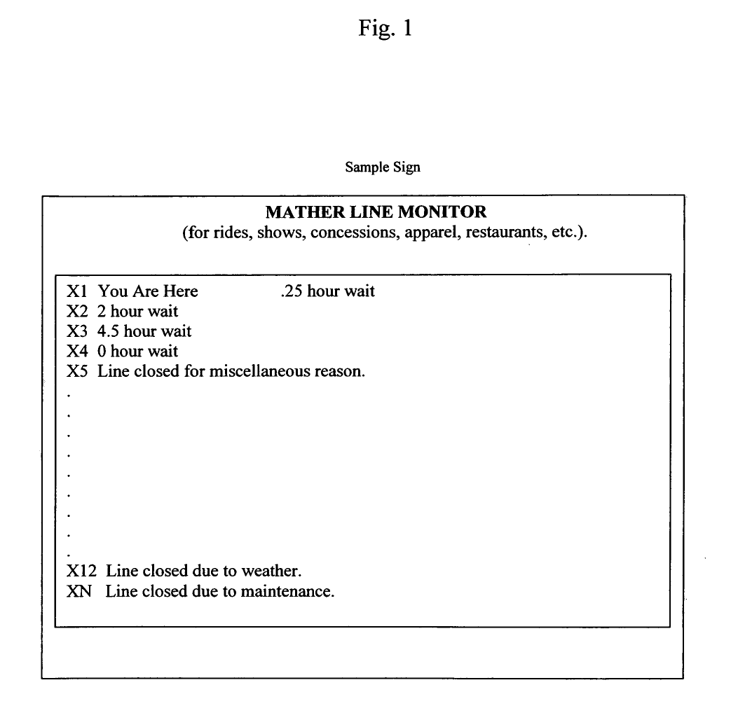

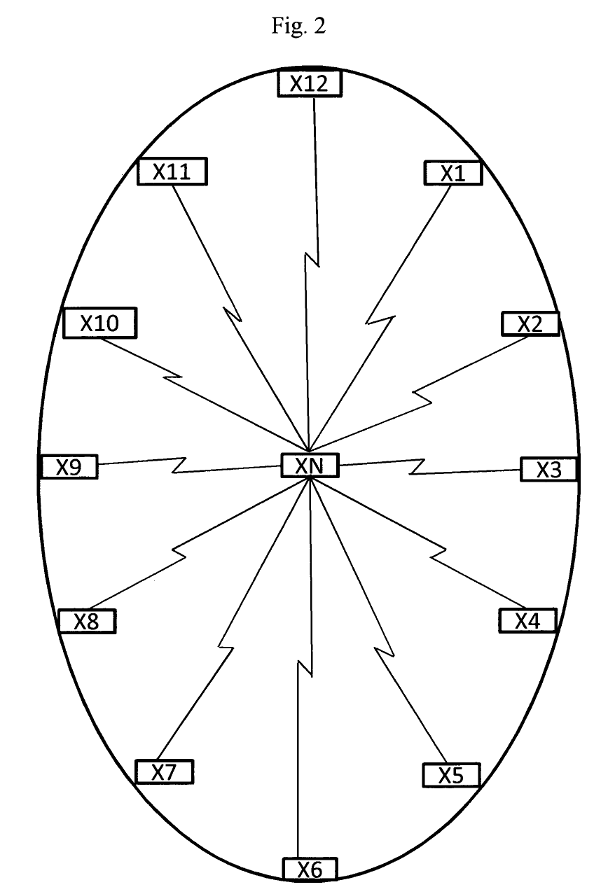

Specification: The Mather Line Monitor consists of a sign and lists the places with lines. Where X1 to XN are places with lines. The sign will appear at the beginning of all places with lines and will be centrally located as necessary. Phone/communication lines will exist between X1 to XN. X1 to XN will have a sign that includes the names of X1 to XN, the status of the line, the length of the line in 15 minute intervals to the nearest 15 minutes updated every 15 minutes. It will display as illustrated in the attached drawings as a fraction of an hour on a sign that is lit up and 4-6 feet tall. Updates to the line will only be conducted at the place of the line specifically and will be updated immediately to all other signs at the same time accordingly.

### CROSS-REFERENCE TO RELATED APPLICATIONS

None

### STATEMENT REGARDING FEDERALLY SPONSORED RESEARCH OR DEVELOPMENT

There are no federally sponsored research or development programs that I (David Mather, the inventor) am aware of regarding this patent.

### REFERENCE TO SEQUENCE LISTING, A TABLE, OR A COMPUTER PROGRAM LISTING COMPACT DISC(S)

None are used for this patent request.

### BACKGROUND OF THE INVENTION

The idea was generated after several years of seeing the need at multiple events in Michigan and Ohio, etc. It will help to keep track of the line length for a given item.

### BRIEF SUMMARY OF THE INVENTION

The invention will be able to monitor and tell how long lines are to help the consumer to decide what they would like to do at that particular event.

### BRIEF DESCRIPTION OF THE VIEWS OF THE DRAWINGS

The drawings are to provide an idea of what the invention would look like and how it could be used. They are broad overviews of what people will see.

### DETAILED DESCRIPTION OF THE INVENTION

The invention will primarily consist of a sign that is updated by someone or something describing the length of a wait for a given item.

### SEQUENCE LISTING

None are used for this patent request.

1. I claim that I am the sole inventor of the Mather Line Monitor and that no-one else has issued a patent for this item. The paragraph below and the attached diagrams will explain and show how it works.
The Mather Line Monitor consists of a sign and lists the places with lines. Where X1 to XN are places with lines. The sign will appear at the beginning of all places with lines and will be centrally located as necessary. Phone/communication lines will exist between X1 to XN.
X1 to XN will have a sign that includes the names of X1 to XN, the status of the line, the length of the line in 15 minute intervals to the nearest 15 minutes updated every 15 minutes. It will display as illustrated in the attached drawings as a fraction of an hour on a sign that is lit up and 4-6 feet tall. Updates to the line will only be conducted at the place of the line specifically and will be updated immediately to all other signs at the same time accordingly.
